(19) United States
(12) Patent Application Publication
(10) Pub. No.: US 2024/0424904 A1
(43) Pub. Date: Dec. 26, 2024

(54) HIGH VOLTAGE ELECTRICAL SHORT CIRCUIT PROTECTION SYSTEM FOR HYBRID VEHICLES

(71) Applicant: FCA US LLC, Auburn Hills, MI (US)

(72) Inventors: Zhentao Xie, Auburn Hills, MI (US); Rudolph Kharpuri, Auburn Hills, MI (US)

(21) Appl. No.: 18/341,411

(22) Filed: Jun. 26, 2023

(51) Int. Cl. B60L 3/00; B60L 3/04; B60L 58/20

(52) U.S. Cl. CPC B60L 3/0046; B60L 3/04; B60L 58/20

(57) ABSTRACT

A short circuit protection system for a hybrid vehicle having an internal combustion engine and high voltage components including an electric drive motor is provided. The short circuit protection system includes a high voltage battery pack, a high speed reactive component and a controller. The high voltage battery pack powers the electric drive motor. The high speed reactive component is configured to move between a normally open position and a closed position, wherein in the closed position, power from the high voltage battery pack is diverted away from the high voltage components and to the high speed reactive component. The controller receives operating conditions of the high voltage components and communicates a signal to the high speed reactive component to move to the closed position based on operating conditions consistent with an electrical short to drain power from the high voltage battery pack.

### FIELD

The present application generally relates to electrical systems on hybrid vehicle and, more particularly, to a short circuit protection system including a high-speed reactive component that diverts energy away from a failed component and related control strategy.

### BACKGROUND

A vehicle hybrid-electric powertrain typically includes an internal combustion engine and at least one electric motor. In some configurations, a hybrid-electric powertrain could include an engine and two or more electric motors. Typically, the electrified portion of the hybrid-electric powertrain vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. When there is a failure in the high voltage battery system, such as a load drawing too much current, a short circuit in the system could lead to potential damage to the vehicle components. Typically, hardware, such as fuses, exists in such systems that can detect such short circuit and break the circuit to protect the components. However, the reaction of such fuses can sometimes occur too late or the fuses themselves can fail to break the circuit. Accordingly, while such conventional short circuit protection systems may work well for their intended purpose, there exists an opportunity for improvement in the relevant art.

### SUMMARY

According to one example aspect of the invention, a short circuit protection system for a hybrid vehicle having an internal combustion engine and high voltage components including an electric drive motor is provided. The short circuit protection system includes a high voltage battery pack, a high speed reactive component and a controller. The high voltage battery pack powers the electric drive motor. The high speed reactive component is configured to move between a normally open position and a closed position, wherein in the closed position, power from the high voltage battery pack is diverted away from the high voltage components and to the high speed reactive component. The controller receives operating conditions of the high voltage components and communicates a signal to the high speed reactive component to move to the closed position based on operating conditions consistent with an electrical short to drain power from the high voltage battery pack.

In some implementations, the controller is further configured to determine a voltage of the high voltage bus and discontinue routing of power back to the high voltage battery pack based on the voltage not being stabilized. The routing of power includes regenerative braking.

In some implementations, the operating conditions consistent with an electrical short include a determination whether one of a current delivered to the high voltage component exceeds a threshold or a voltage of the high voltage bus is less than a threshold.

According to another example aspect of the invention, the controller is further configured to route power from the high voltage battery pack to alternate high voltage components not associated with the electrical short.

In some implementations, the short circuit protection system further comprises a contactor that selectively electrically connects the high voltage battery to the high voltage bus. The controller commands the contactor to move to an open position wherein the high voltage battery is disconnected from the high voltage bus based on the voltage of the high voltage bus being stabilized.

In some implementations, the controller is configured to direct the internal combustion engine to provide sole propulsion power to the vehicle based on an electrical short detection.

A method of operating a short circuit protection system for a hybrid vehicle having an internal combustion engine, high voltage components including an electric drive motor, and a high voltage battery pack that powers the electric drive motor is provided. Operating conditions of the high voltage components operating on a high voltage bus are received at a controller. Control determines whether the operating conditions are indicative of a shorted high voltage component of the high voltage components. A signal is communicated to a high speed reactive component, based on a determination that operating conditions are indicative of a short, wherein the high speed reactive component moves from an open condition to a closed position to divert power from the high voltage battery pack away from the shorted high voltage component to the high speed reactive component.

In additional aspects, determining whether the operating conditions are indicative of a short include one of determining whether a current delivered to the high voltage component exceeds a threshold and determining whether a voltage of the high voltage bus is less than a threshold. Control determines whether a voltage on the high voltage bus is stabilized and discontinues routing of power back to the high voltage battery pack based on a determination that the voltage on the high voltage bus is not stabilized. Discontinuing routing of power includes discontinuing regenerative braking power.

In additional features, control routes electrical power from the high voltage battery pack to alternate high voltage components other than the shorted high voltage components. The short circuit protection system further includes a contactor that selectively electrically connects the high voltage battery to the high voltage bus. Control commands the contactor to move to an open position wherein the high voltage battery is disconnected from the high voltage bus based on the determination that the voltage of the high voltage bus being stabilized. Control commands the internal combustion engine to provide sole propulsion power of the vehicle based on the detection of the shorted high voltage component. Control communicates a signal to an instrument cluster of the hybrid vehicle indicative of an electrical short detection based on the determination that operating conditions are indicative of a short.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a mild hybrid vehicle that incorporates a short circuit protection system according to the principles of the present application;

FIG. 2 is an exemplary control logic flow for operating the short circuit protection system of FIG. 1; and

FIG. 3 is an exemplary circuit incorporating a short circuit protection system of FIG. 1.

### DESCRIPTION

As discussed above, in the electrified portion of the hybrid-electric powertrain vehicle a high voltage battery system may include various fuses that can detect an over current and break the circuit to protect the various components. However, these known solutions of short circuit protection are reactive in nature which can occur too late. In other words, the fuse may break as designed, but the break may occur after the failure and damage to the respective components. In this regard, when there is a failure in the high voltage electrical system like a short circuit in one of the components and the fuse fails to open the circuit in time, the short circuit protection system according to the present disclosure can detect such anomalies and proactively prevent the component and vehicle as a whole from further failures by stabilizing the energy source using a high-speed reactive component or trigger a mechanism to divert the energy source away from the failed component.

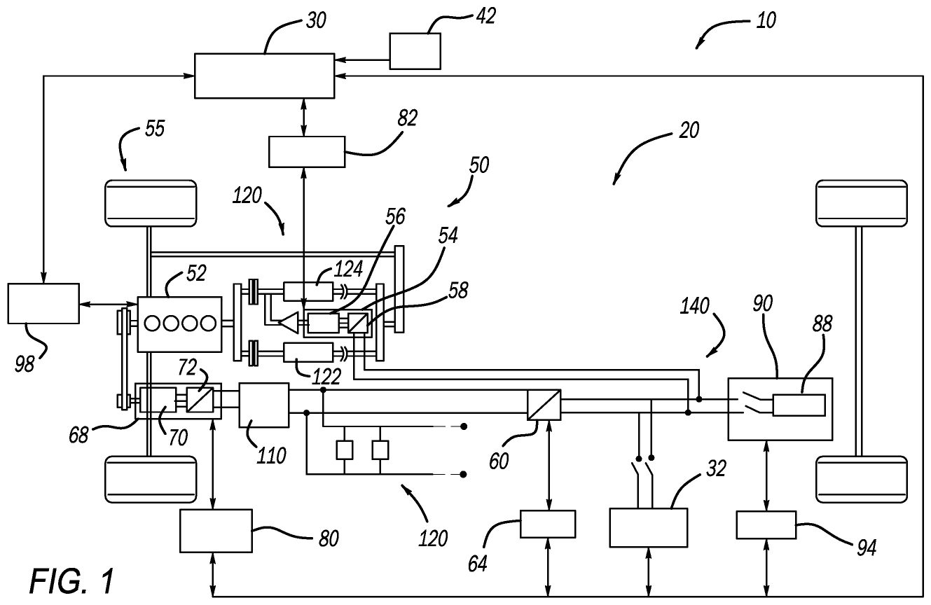

With initial reference to FIG. 1, a mild hybrid vehicle 10 having a short circuit protection system 20 according to one example of the present is shown. The short circuit protection system 20 can generally include a hybrid control processor, referred herein as hybrid controller 30 and a high speed reactive component 32. The controller 30 can communicate signals to an instrument cluster or infotainment system 42 indicative of operating conditions. The short circuit protection system 20 cooperates with a hybrid powertrain 50. The hybrid powertrain 50 generally includes an internal combustion engine 52 and an electric drive motor 54 that generally cooperate to provide power to drive wheels 55. The electric drive motor 54 includes a motor 56 and an inverter 58.

The hybrid powertrain 50 can additionally include a DC/DC converter 60, an auxiliary power module (APM) 64, and a belt starter generator 68. The belt starter generator 68 can be a 12 volt generator and include a motor 70 and an inverter 72. The hybrid powertrain 50 can include a 12 volt motor control processor 80, a 48 volt motor control processor 82, a 48 volt traction battery pack 88, a contactor 90, a battery pack control module (BPCM) 94, and an engine control module (ECM) 98.

The DC/DC converter 60 is an actuator which converts high voltage (48 volts) to low voltage (12 volts) to charge a 12-volt battery 110 and support various 12 volt loads 120 of the mild hybrid vehicle 10. The APM 64 is a controller that controls the DC/DC converter 60. The APM 64 can monitor a status of the DC/DC converter 60 such as operation mode, and failure status. The APM 64 can further measure an input and output current and voltage of the DC/DC converter 60. In addition, the APM 64 can control the DC/DC converter 60 to operate in a specific mode (e.g., boost mode, etc.) and/or reach specific voltage set points. The APM 64 can bi-directionally communicate with the hybrid controller 30. In this regard, the APM 64 can control and monitor the DC/DC converter 60 through the APM 64.

The BSG 68 is an actuator which is used as a starter when the mild hybrid vehicle 10 needs to crank the engine 52. The BSG 68 can operate in alternator mode to charge the 12 volt battery 110 and support 12 volt loads while the engine 52 is running. The 12 volt BSG 68 is directly controlled by the 12 volt MCP 80. The 12 volt MCP 80 is a controller that controls the 12 volt BSG 68 using bi-directional communication. The hybrid controller 30 can control the 12 volt BSG 68 by forwarding the signals such as operation state, torque command and voltage setpoints to the 12 volt MCP 80. The 12 volt MCP 80 provides feedback related to the 12 volt BSG 68 such as operation status, output current and voltage to the hybrid controller 30.

The electric drive motor 54 is a 48 volt motor and inverter that acts as an actuator which is integrated in a hybrid dual clutch transmission 120 having a first transmission 122 and a second transmission 124. Other arrangements are contemplated. The electric drive motor 54 can be used to propel the mild hybrid vehicle 10 electrically without use of the engine 52. The electric drive motor 54 can also assist in engine and boost the propulsion power, or to start the engine 52, or to charge the high voltage battery 88. The 48 volt MCP 82 is a controller that has similar functionality as the 12 volt MCP 80.

The 48 volt traction battery pack 88 is a power source for high voltage devices such as the electric drive motor 54 and DC/DC converter 60. The contactor 90 is an electromechanical switching device that is used to connect the 48 volt battery 88 to a high voltage bus 140. In examples, the contactor 90 can be integrated with the 48 volt battery pack 88.

The BPCM 94 is a control module that monitors various parameters such as, but not limited to, battery current, voltage, and contactor status. The BPCM 94 can estimate a state of charge (SOC) and charging/discharging power limits. The BPCM 94 can control the contactor 90 to open or close based on detected parameters. The BPCM 94 can bi-directionally communicate with the hybrid controller 30. In this regard, the hybrid controller 30 can control and monitor the 48 volt battery 88 through the BPCM 94.

The ECM 98 can be configured to control the engine 52 and provide torque and speed to drive the BSG 68 to charge the 12 volt battery 110 and provide power to the 12 volt loads. The hybrid controller 30 can control and monitor the engine 52 through the ECM 98.

The high speed reactive component 32 is normally open (as shown in FIG. 1). When the controller 30 determines that specific criteria has been met (consistent with a short circuit or component failure), the controller 30 sends a signal to the high speed reactive component 32 to trigger and move to a closed position. Again, a short circuit can cause excessive current to be delivered that could cause damage to a component (such as the drive motor 54) and/or a thermal event. When the high speed reactive component 32 is moved to a closed position, an amount of current going from the battery 88 to the drive motor 54 is diverted to the high speed reactive component 32, to reduce or eliminate current that would otherwise be sent to the drive motor 54.

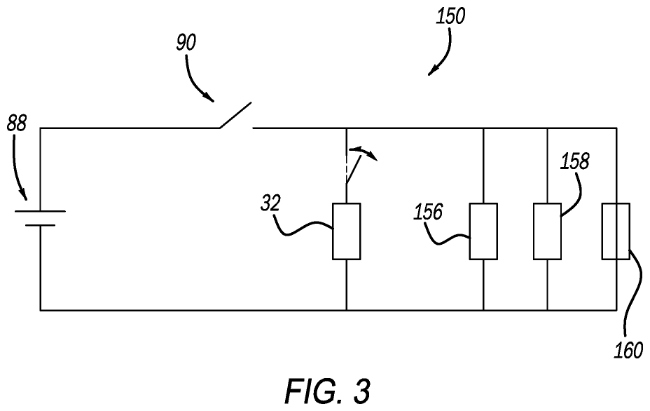

Turning now to FIG. 3, additional features of the short circuit protection system 20 will be described. An exemplary circuit 150 is shown. The circuit 150 includes the 48 volt battery 88, the contactor 90, and the high speed reactive component 32. High voltage vehicle loads are represented at 156 and 158. A shorted component is shown at 160. As discussed herein, the high speed reactive component 32 is used when a short circuit failure occurs. The high speed reactive component 32 operates to drain the energy of the battery 88 to prevent further components or vehicle failures. In the example shown, the high speed reactive component 32 moves generally from an open position (solid line) to a closed position (broken line) when short circuit failure is detected by the hybrid controller 30.

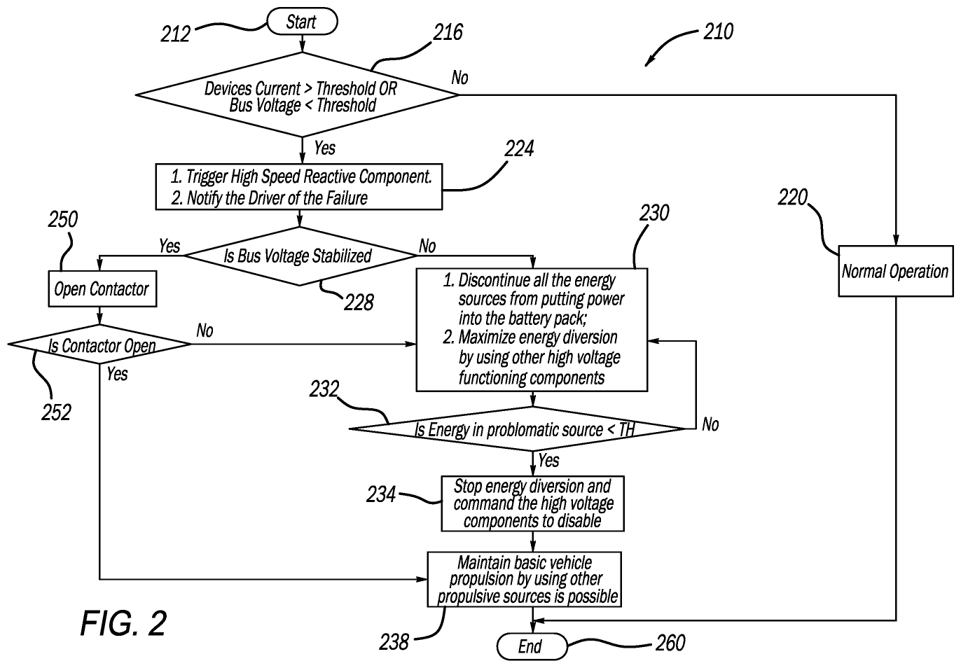

With continued reference to FIGS. 1 and 3 and additional reference now to FIG. 2, an exemplary control logic flow 210 for operating the short circuit protection system 20 according to one example will be described. Control begins at 212. At 216 control monitors the current of all high voltage devices of the mild hybrid vehicle 10 and a voltage of the bus 140. It will be appreciated that in the example shown, the only high voltage devices are the drive motor 54 and DC/DC converter 60. The short circuit protection system 20 can also be adapted for use when there are more high voltage devices, such as multiple electric drive motors.

Control determines whether any high voltage device (such as the drive motor 54) current is higher than a threshold (signifying a short) or whether the bus voltage (measured at the BPCM 94 when the contactor 90 closes) drops below the threshold. The threshold can be any target current that is consistent with a short circuit. If control determines that any device current is higher than a threshold or that the bus voltage drops below the threshold, control proceeds to step 224. If control determines that any device current is not higher than a threshold and the bus voltage has not dropped below a threshold, control proceeds to normal operation at 220. If control determines that any device current is higher than a threshold or that the bus voltage has dropped below the threshold, control proceeds to 224 where the high-speed reactive component 32 is triggered. The high-speed reactive component 32 can be triggered (moved from an open to closed position) by any suitable means such as electrical activation or by software control.

When the high-speed reactive component 32 is triggered, current is immediately diverted from the shorted component 160 to the high speed reactive component 32 causing the voltage of the high voltage bus 140 to be stabilized. As represented in FIG. 3, the high voltage components 156 and 158 (such as the drive motor 54, and DC/DC converter 60, FIG. 1) are then protected. In this regard any damage to the high voltage components or thermal incident can be avoided. A signal can be sent from the controller 30 to the driver such as to the instrument cluster or infotainment module 42 conveying to the driver that a failure has occurred.

At 228, control determines whether the voltage of the high voltage bus 140 has been stabilized. If control determines that the voltage of the high voltage bus 140 has not been stabilized, control discontinues all energy sources from delivering power (such as regenerative braking etc.) into the battery pack 88 at 230. Control maximizes energy diversion by rerouting voltage to other high voltage vehicle loads in an effort to dissipate the power of the battery 88 as soon as possible. At 232 control determines whether the energy in the battery pack 88 or the energy in the problematic source is less than a threshold.

If the energy in the battery pack 88 or the energy in the problematic source is not less than the threshold, control loops to 230. If the energy in the battery pack 88 or the energy in the problematic source is less than the threshold, control stops energy diversion and commands the high voltage components (such as the drive motor 54, and DC/DC converter 60 FIG. 1) to disable at 234. In examples, the threshold can be consistent with a battery pack 88 having no charge or empty. At 238, control maintains basic propulsion of the mild hybrid vehicle 10 by using other propulsion sources (e.g., the engine 52) if available.

Returning to step 228, if control determines that the voltage of the bus 140 has been stabilized, control proceeds to step 250 and the contactor 90 is commanded open. At 252, control determines whether that the contactor 90 is open. If the contactor 90 is open, control proceeds to step 238. If control determines that the contactor 90 is not open (such as when the contactor 90 may have been welded closed during a short), control proceeds to step 230. In this regard, the short circuit protection system 20 provides additional protection to the battery pack 88 when the contactor 90 is unable to close even after commanded. In examples, the battery pack 88 may be undesirably supplying excess power to a problematic high voltage components (such as the drive motor 54, and DC/DC converter 60 FIG. 1), that could otherwise lead to damage or a thermal event in that components. In such a condition, control disconnects the battery pack 88 from the shorted component. Control ends at 260.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A short circuit protection system for a hybrid vehicle having an internal combustion engine and high voltage components including an electric drive motor, the short circuit protection system comprising:
a high voltage battery pack that powers the electric drive motor over a high voltage bus;
a high speed reactive component configured to move between a normally open position and a closed position, wherein in the closed position, power from the high voltage battery pack is diverted away from the high voltage components and to the high speed reactive component; and
a controller that receives operating conditions of the high voltage components and communicates a signal to the high speed reactive component to move to the closed position based on operating conditions consistent with an electrical short to drain power from the high voltage battery pack.

2. The short circuit protection system of claim 1, wherein the controller is further configured to determine a voltage of the high voltage bus and discontinue routing of power back to the high voltage battery pack based on the voltage not being stabilized.

3. The short circuit protection system of claim 2, wherein the routing of power includes regenerative braking.

4. The short circuit protection system of claim 2, wherein the operating conditions consistent with an electrical short include a determination whether one of a current delivered to the high voltage component exceeds a threshold or a voltage of the high voltage bus is less than a threshold.

5. The short circuit protection system of claim 2, wherein the controller is further configured to route power from the high voltage battery pack to alternate high voltage components not associated with the electrical short.

6. The short circuit protection system of claim 2, further comprising a contactor that selectively electrically connects the high voltage battery to the high voltage bus.

7. The short circuit protection system of claim 2, wherein the controller commands the contactor to move to an open position wherein the high voltage battery is disconnected from the high voltage bus based on the voltage of the high voltage bus being stabilized.

8. The short circuit protection system of claim 2, wherein the controller is configured to direct the internal combustion engine to provide sole propulsion power to the vehicle based on an electrical short detection.

9. The short circuit protection system of claim 1, wherein the controller is configured to communicate a signal to an instrument cluster of the hybrid vehicle indicative of an electrical short detection.

10. A method of operating a short circuit protection system for a hybrid vehicle having an internal combustion engine, high voltage components including an electric drive motor, and a high voltage battery pack that powers the electric drive motor over a high voltage bus, the method comprising:
receiving, at a controller, operating conditions of the high voltage components operating on the high voltage bus;
determining whether the operating conditions are indicative of a shorted high voltage component of the high voltage components; and
communicating a signal to a high speed reactive component, based on a determination that the operating conditions are indicative of a short, wherein the high speed reactive component moves from an open condition to a closed position to divert power from the high voltage battery pack away from the shorted high voltage component to the high speed reactive component.

11. The method of claim 10, wherein determining whether the operating conditions are indicative of a short includes one of:
determining whether a current delivered to the high voltage component exceeds a threshold; and
determining whether a voltage of the high voltage bus is less than a threshold.

12. The method of claim 10, further comprising:
determining whether a voltage on the high voltage bus is stabilized and discontinuing routing of power back to the high voltage battery pack based on a determination that the voltage on the high voltage bus is not stabilized.

13. The method of claim 12, wherein discontinuing routing of power includes discontinuing regenerative braking power.

14. The method of claim 10, further comprising:
routing electrical power from the high voltage battery pack to alternate high voltage components other than the shorted high voltage components.

15. The method of claim 12, wherein the short circuit protection system further includes a contactor that selectively electrically connects the high voltage battery to the high voltage bus, the method further comprising:
commanding the contactor to move to an open position wherein the high voltage battery is disconnected from the high voltage bus based on the determination that the voltage of the high voltage bus is stabilized.

16. The method of claim 12, further comprising:
commanding the internal combustion engine to provide sole propulsion power of the vehicle based on the detection of the shorted high voltage component.

17. The method of claim 12, further comprising:
communicating a signal to an instrument cluster of the hybrid vehicle indicative of an electrical short detection based on the determination that operating conditions are indicative of a short.
